(19) United States
(12) Patent Application Publication
(10) Pub. No.: US 2003/0094555 A1
(43) Pub. Date: May 22, 2003

(54) Towel holder

(76) Inventor: Darin Prizzi, Naples, FL (US)

Correspondence Address: ALLEN D. BRUFSKY, ESQ., ALLEN D. BRUFSKY, P.A., 8930 BAY COLONY DRIVE, UNIT # 604, NAPLES, FL, 34108, US

(21) Appl. No.: 09/993,820

(22) Filed: Nov. 16, 2001

(51) Int. Cl. F16B 1/00; E04G 3/00; G09F 7/18; A47B 96/06

(52) U.S. Cl. 248/230.7; 248/231.81; 248/316.7; 248/214

(57) ABSTRACT

The holder is a plastic tube split lengthwise into substantially mirror image halves forming two opposed clamping members hingedly connected by spring operated handles which activate opening and closing of the clamping members to engage a towel or other items hanging on a support.

### BACKGROUND OF THE INVENTION

1. Field of the Invention

This invention relates to a holder for towels, blankets or similar items and, in particular, to a plastic tube holder which maintains a towel or blanket securely attached to a chair, such as a beach chair, and prevents the towel or blanket from slipping from the chair.

2. Description of Prior Art

There is a problem in the prior art relative to holding devices which will securely hold an item to an object and will prevent the item from slipping.

Experience has taught us that in the course of hanging or placing an item on an object, one is frequently faced with the problem of the item slipping down or falling off the object. Such is the situation when placing a towel or blanket on a beach chair or the like to shield one's body from the chair. The towel or blanket is constantly slipping down and defeating its purpose by allowing the body to be in contact with the chair. Similar situations exist when hanging or placing blankets, clothes, curtains, sheets of material or other hanging items on a support. Thus, there is a need of a simple device which will securely hold an item to an object.

In my prior U.S. Pat. No. 5,611,123, a holder is provided which is a unitary device having opposing moveable parts. In operating the holder, the moveable parts are actuated to an open position so as to enclose and then clamp the holder to an object, such as a chair in the clamped or locked position. The improved holder has the advantage of being easily operated by handles conveniently positioned on the movable parts.

The holder includes a plastic tube having a bore extending therethrough. The plastic tube is split lengthwise into two substantially mirror image halves forming clamping members which are joined together along their adjacent split edges by at least one torsionally operated handle positioned on one side of the tube at the aligned split edges. The holder tube member split halves are actuated to the open and closed positions respectively by applying and releasing pressure to the handle or handles by means of one's fingers. When pressure is applied to one side of the holder, the opposite side clamping member of the split tube opens up allowing them to enclose the object. The holder will also securely clamp a towel to the top of a beach chair allowing the towel to hang down without slipping off of the chair. In addition to its use as a towel holder, the unique holder has many other uses such as securing curtains, and various hanging objects or other materials, to a support.

### SUMMARY OF THE INVENTION

This invention relates to an improvement of the towel holder, and particularly a hinge mechanism between the clamp halves for opening and closing the clamp or holder.

In one form of the improved towel holder, the hinge is a living hinge formed between the mirror image clamp halves enabling the holder to be molded in any length, in one lightweight plastic (non-rusting) piece rather than two separate pieces split along a line from each other, with integral handles to grasp to open the holder against the force of the hinge. In a second form, a torsion spring hinge is employed for ease of assembly of the split mirror image clamping members of the holder.

Accordingly, the improved towel holder comprises a circular plastic tube split lengthwise longitudinally into substantially mirror image straight halves forming two opposed clamping members hingedly joined together at one facing pair of split edges, each clamping member provided with at least one separated handle member positioned on one of the clamping member halves and opposite another on the other half of the member. The oppositely positioned handle members are separated on each clamping member and in one embodiment, the clamping member halves are hingedly connected by a living hinge along a first pair of separated edges to activate opening and closing of the opposed clamping member and the second pair of split edges which engage and are secured to the support by applying and removing pressure on the oppositely positioned handle members. In a second embodiment, a hinge mechanism employing a torsion spring is provided on each member adjacent one pair of split or separated edges and contact the handle members to open and close the clamping members upon movement of the opposed handle members.

### BRIEF DESCRIPTION OF THE DRAWINGS

A better understanding of the present invention will be had upon reference to the following detailed description when read in conjunction with the accompanying drawings, where like reference characters refer to like parts through out the several views, and in which:

FIG. 1 is a perspective view of the improved towel holder in use,

FIG. 2 is a top plan view of the one embodiment of the improved towel holder;

FIG. 3 is an end view of the improved towel holder of FIG. 2;

FIG. 3a is an end view of the towel holder of FIG. 3, “Opened;”

FIG. 4 is a cross sectional view taken substantially along lines 4-4 of FIG. 2;

FIG. 5 is a perspective view of a second embodiment of the improved towel holder of the invention having a living hinge;

FIG. 6 is an end view of the embodiment of the invention of FIG. 5; and

FIG. 6a is an end view of the embodiment of the invention of FIG. 5 opened.

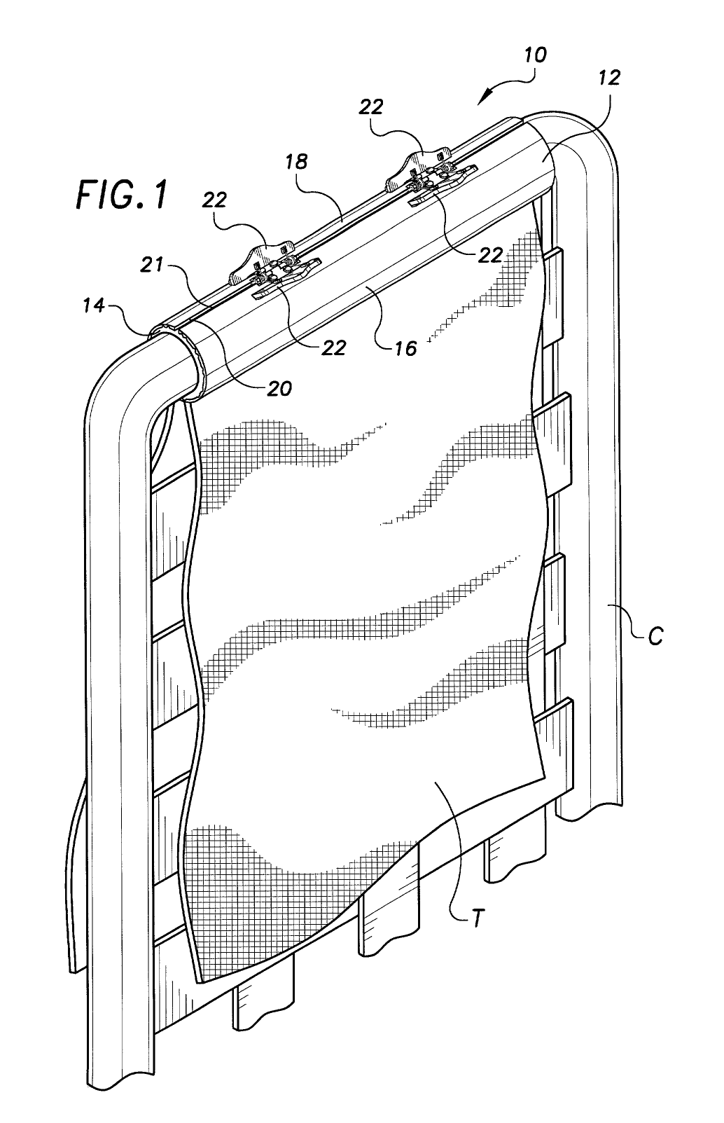

### DETAILED DESCRIPTION

The unique holder disclosed herein is not merely a complicated holder or clamp which is difficult to operate and must be stored away when not in use and performs only a single function such as holding a towel. To the contrary, the unique holder of the present invention is a simple device which is relatively easy to operate. Because of its pleasing appearance and structure, it can also be attached to the object, such as a beach chair, for safekeeping when not in use as a holder, thus adding a pleasant and unique feature to the object. Further, it is not limited to holding only one item but is capable of holding up various articles such as: towels, blankets, clothes, curtains, various sheets of material or other hanging items to support.

Referring to the drawings, a holder 10 which is constructed in accordance with this invention includes plastic tube 12 having a bore 14 extending through its entire length. Plastic tube 12 is split or separated lengthwise into two substantially mirror image halves forming a top clamping member 16 and bottom clamping member 18 having two pairs of adjacent split or separated edges 20, 21. At least one integrally attached or molded opposing handle member 22 is spaced at intermediate positions on one side of each clamping member adjacent one pair of the split edges 20, 21 and has an opening 24 therebetween.

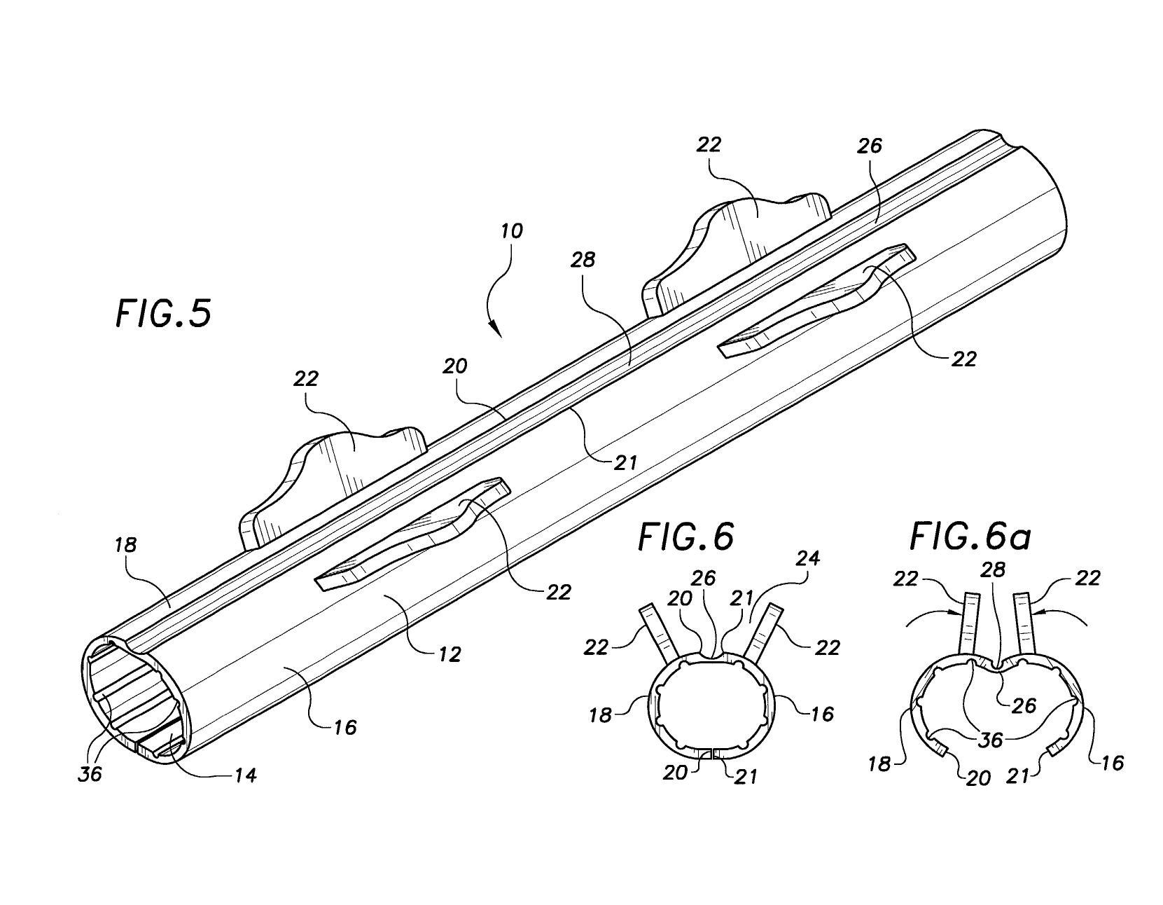

In one embodiment of the invention depicted as FIGS. 5 to 6a, a spring hinge mechanism comprising a living hinge 26 formed by a groove 28 defining a first pair of the separated or split edges 20, 21 is provided between and connecting the clamping member halves 16, 18 of the tube 12 and enables the clamping member halves to pivot about the hinge 26 when the opposed handle members 22 are moved toward each other through space 24 to open the space between the second pair of completely split and separated edges 20, 21 and upon release, to clamp a towel T and the clamping members about a chair C or blanket or the like between the clamping members. Clamping members 16 and 18 have serrated interior curved surfaces 36 throughout their length in order that they will firmly grip hold onto the object C and towel T therebetween.

The handle members 22 may be molded integral with clamp halves 16, 18 and in fact, the entire holder 10 can be molded in one piece with a living hinge 26. The plastic tube 12 can be formed from polypropylene or other lightweight plastic. Polypropylene is preferred as it has a living memory.

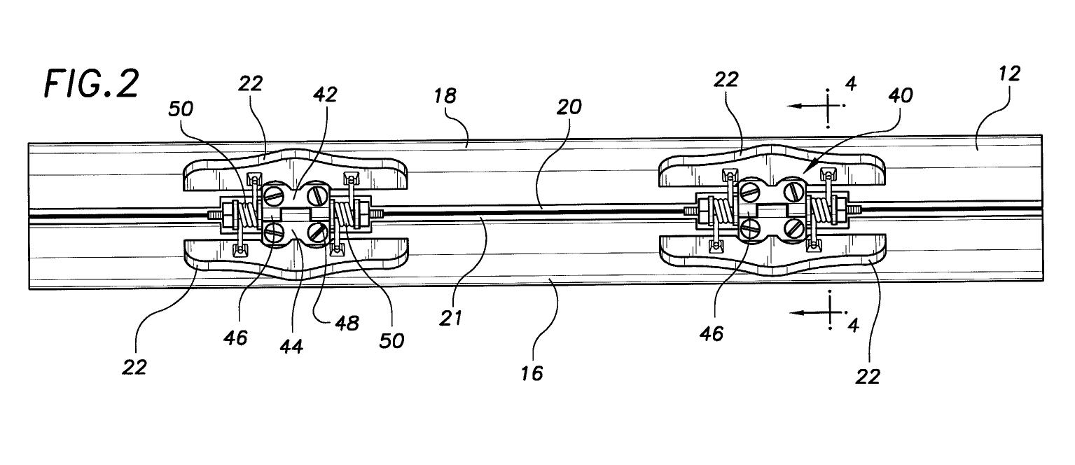

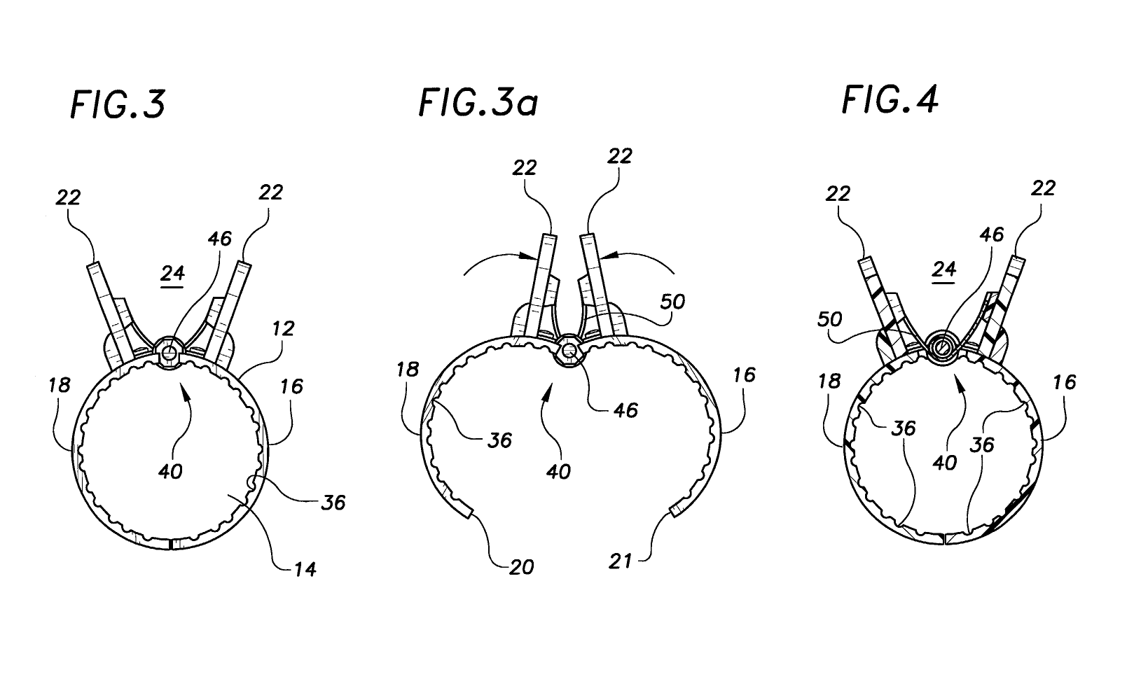

In a second embodiment of the invention illustrated in detail in FIGS. 2 to 4, inclusive, a torsion hinge mechanism 40, shown in FIG. 2 can be used in lieu of hinge 26. The hinge mechanism 40 includes mating hinge plates 42, 44 on each clamping member 16, 18 adjacent a first pair of split edges 20, 21 and a pair of opposed handle members 22. A hinge pin 46 is inserted in between grooves 48 in hinge plates 42, 44 enabling the clamping members 16, 18 to pivot relative to each other. A torsion spring 50 is provided on each end of the pin 46 biasing the handles 22 away from each other and the clamping members 16, 18 towards each other. Grasping the handles 22 and moving them against the force of the springs 50 (as shown in FIG. 3a) opens the space between the second pair of split edges 20, 21 on the clamping members and releasably closes the space because of the bias of the springs to grip a chair C and towel T or the like between the clamping member halves 16, 18.

The hinge plates 42, 44 may be riveted or screwed to the outer diameter of the tube 12.

Holder 10 can be of any length and one or more can be employed with an outside tube diameter of about one and three quarter inches more or less depending upon the size of the object to be enclosed and the tube about five thirty seconds of an inch thickness. Serrated interior curved surfaces 32 project into the underlying surface and securely hold the clamped object in place.

Having now described the invention, it will be apparent to one of ordinary skill in the art that many changes and modifications can be made thereto without departing from the spirit and scope of the invention as set forth herein.

What is claimed is:

1. In combination a releasable tube holder and a longitudinal support comprising,
said tubular holder including a circular plastic tube split lengthwise into longitudinally mirror image straight halves forming two opposed clamping members joined together at across one pair of split edges and separated by a second pair split edges, each clamping member provided with at least one separated handle member positioned on one of the clamping member halves and opposite another handle member on the other clamping member half, said clamping member halves being hingedly connected by a living hinge between said first pair of split edges to activate opening and closing of the opposed clamping members and separation and closing of the second pair of split edges which engage and are secured to the support by applying and removing pressure on the oppositely positioned handle members.

2. In combination a releasable tube holder and a longitudinal support comprising,
said longitudinal support supporting a towel hanging therefrom,
said tubular holder including a circular plastic tube split lengthwise into longitudinally mirror image straight halves forming two opposed clamping members joined together at across one pair of split edges and separated by a second pair of split edges, each clamping member provided with at least one separated handle member positioned on one of the clamping member halves and opposite another handle member on the other clamping member half, said clamping member halves being hingedly connected by a living hinge between said first pair of split edges to activate opening and closing of the opposed clamping members and separation and closing of the second pair of split edges which engage and are secured to the support by applying and removing pressure on the oppositely positioned handle members.

3. The holder according to claim 1 wherein said plastic tube has an interior surface which has been serrated.

4. The holder according to claim 1 wherein said plastic tube is formed from polypropylene.

5. The holder and support according to claim 2 wherein the support is a beach chair having a longitudinal top support.

6. In combination, a releasable tube holder and a longitudinal support comprising,
said tubular holder including a circular plastic tube split lengthwise into longitudinally mirror image straight halves forming two opposed clamping members joined together at across one pair of split edges and separated by a second pair split edges, each clamping member provided with at least one separated handle member positioned on one of the clamping member halves and opposite another handle member on the other clamping member half, said clamping member halves being hingedly interconnected with a hinge pin connected by a hinge on each clamp half said first pair of split edges, a torsion spring between each of said hinge plates to activate opening and closing of the opposed clamping members and separation and closing of the second pair of split edges which engage and are secured to the support by applying and removing pressure on the oppositely positioned handle members.

7. In combination, a releasable tube holder and a longitudinal support comprising,
said tube holder including a circular plastic tube split lengthwise longitudinally into mirror image straight halves forming two opposed clamping members joined together at one pair of straight across split edges and separated by another pair of split edges, each clamping member provided with at least one separated handle member positioned on one of the clamping members and opposite another handle member on the other clamping member, said clamp halves being hingedly connected by a hinge member along one pair of said split edges to activate opening and closing of the opposed clamping members and separation and closing of the other pair of split edges which engage and are secured to the support by applying and removing pressure on the oppositely positioned handle members.

8. The holder of claim 7 wherein said hinge member extends along and in the direction of said one pair of straight across split edges hingedly connected by a hinge member extending along the axis of the first pair of split edges.

9. The holder of claim 8 wherein said hinge member is a living hinge.

10. The holder of claim 8 wherein said hinge member extends axially along the first pair of split edges.
